(19) United States
(12) Patent Application Publication
(10) Pub. No.: US 2016/0225506 A1
(43) Pub. Date: Aug. 4, 2016

(54) Unique magnetic effect and applications

(71) Applicant: STEN R. GERFAST, Mendota Heights, MN (US)

(72) Inventor: STEN R. GERFAST, Mendota Heights, MN (US)

(21) Appl. No.: 14/544,670

(22) Filed: Jan. 31, 2015

(51) Int. Cl. H01F 7/13; H02K 11/00; H02K 1/24; H01F 7/08; H02K 1/16

(52) U.S. Cl. CPC H01F 7/13; H01F 7/081; H02K 1/165; H02K 1/246; H02K 11/0015

(57) ABSTRACT

The present invention describes a unique magnetic attraction effect between two soft iron parts. One soft iron part is a profile, with a slot, having a conductor inside the profile. The second soft iron part, named the armature, can have any shape or form, as long as it covers the slot in the profile

A short electrical pulse into the conductor permanently attracts the profile and the armature to each other, even after the pulse is removed.

This is a unique magnetic attraction, contrary to what is known today, but can also be incorporated into a magnetic effect motor, having a central soft iron rotating rotor surrounded by a plurality of soft iron, square armatures having on the inside a conductor or conductors energized by pulses in synchronism with the rotors angular position, creating continuous rotation of the rotor as long as pulses are supplied.

### BRIEF DESCRIPTION

The present invention describes a unique magnetic attraction effect between two soft iron parts. One soft iron part is a profile, with a slot, having a conductor inside the profile. The second soft iron part, named the armature can have any shape or form, as long as it covers the slot in the profile

A short electrical pulse into the conductor permanently attracts the profile and the armature to each other, even after the pulse is removed.

This is a unique magnetic attraction, contrary to what is known today that two soft iron parts do not become permanent magnets even after some form of pulsing or charging.

If the armature, in this patent application, is made to rotate on a shaft and bearings, it can be a rotor for a motor that uses this magnetic effect. If this rotor is surrounded by a plurality of profiles which are having conductor/conductors inside the profiles, and are pulsed in synchronism with the rotors angular position, the rotor will continue to rotate as long as pulses are supplied. This motor is again unique because the armature/rotor has no copper windings, no magnets and has no laminations. It is also unique because the plurality of armatures or motor stators, which contains no multiplicities of copper windings, is only having inside conductors for pulse application.

This unique magnetic effect, can be either used to assemble soft iron parts into mechanical assemblies, or for toys or puzzles, or it can be used as an electric motor. Regardless of its future uses, it is both described here and in this Paten Application, as the “Gerfast effect”.

### BACKGROUND AND RELATED ART

Many text books are describing the usual magnetic properties.

Bosorth in “Ferro magnetism” explains “magnetic attraction” as occurring when small magnetic domains align themselves”

John Mallinson in his book “Fundamentals of magnetic recording” explains it more precisely: Iron has 26 electrons orbiting around the proton. The electrons are organized in successive electron atomic shells: 1s, 2s, 2p, 3s, 3p, 4s, etc. with all these shells having an equal number of electrons spinning “up” as spinning “down”.

In shell 3d, however, 5 electrons is spinning “up” but only one electron is spinning “down” It is this un-balance that accounts for the unusual property of iron being a magnetic material that can be magnetized, and de-magnetized.

The Applicant postulates that a momentary pulse into a conductor in the slotted profile upsets the balance in the 3d electron shell to a possible 4 “up” 2 “down” or a 3 “up” 3 “down” and is describing this as “the Gerfast Effect”.

A momentary pulse in a conductor obeys the known “right hand rule” and “the left hand rule” shown in many text books, and also in FIG. 5

It is also very well known that the magnetic flux lines has a “reluctance” to travel in air, and therefore travels in any magnetic material that surrounds the conductor.

In this Application the conductor is surrounded by a soft iron profile in which the flux lines is traveling, and is being enhanced by the soft iron.

However the profile has a slot, which is “air”, and therefore “urges” the magnetic lines to attract the adjacent “armature” to close any air gap.

All electrons are spinning at a tremendous speed around any proton, and it would be expected that any change from the normal “5 up-1 down” in iron would occur very rapidly.

However iron has a “known reluctance” before any magnetic change occurs.

This reluctance is described in the text books as:

The opposition offered by a magnetic potential difference, to opposite flux.”

It is therefore reasonable to expect that a current and voltage pulse of some time period is needed to overcome the reluctance and to achieve a magnetic attractive “bonding”.

This time period would of course depend on the pulse source's capability, the dimensions of the profile and the armature, and the resistance/impedense of the conductor.

The unique magnetic effect described in some claims in this Application are stated as “permanent”, but the Applicant can only state that the permanent attraction has been verified for approximately 9 months between a profile and an armature. After that the profile and the armature are pulled apart, they revert to their non-magnetic soft iron state.

Text books are stating the usual known fact that any magnetic effect, meaning that any magnetic attraction or repulsion, is governed by “magnetic square law”. A magnet will attract an iron part by a magnetic attractive force that is increasing by the square of the distance between the two parts. This fact can be used, for example, in a motors air gap between the rotor and the stator, If the motors air gap is decreased by half the magnetic flux in the gap increases by a factor of four.

In this Application it is stated: “in close proximity” or “ closely spaced” to make use of the square law.

In summary: The motor described in this invention does not have

1 any magnets

2 any laminations

3 any windings

4 any brushes

5 any commutator

For reference some magnetic fundamentals from text books are listed here:

### Permeability of Materials

Permeability=

“The property of a magnetizable substance that determines the degree in which it modifies the magnetic flux in the region occupied by it, in a magnetic field.”

Iron=200 to 5,000 permeability.

“Cold rolled”=180 to 2,000 permeability.

### Reluctance of Materials

Reluctance=

“The opposition offered by a magnetic potential difference, to the opposite flux.” (Which is the reciprocal of magnetic Permeability)

Magnetic field due to current I in a circular conductor with a radius r equals

$$H = \frac{2 \text{?} I}{r}$$

$$\text{?} \text{indicates text missing or illegible when filed}$$

(“Making soft iron into permanent magnets” is named “The Gerfast effect”)

Annealing is increasing magnetic flux

“Soft iron” includes cold rolled, silicon containing iron, purified iron, cast iron.

Square, round, oval, triangular, irregular profile having a slot in one face with a flat area next to the slot are to be considered in this Application.

Long section (24 inches, profile/armature) have usefully been magnetized.

“Armature” definition: “Soft iron that connects the poles of a magnet”

### BRIEF DESCRIPTION OF THE DRAWINGS

FIG. 1 is showing a soft iron profile and a soft iron armature. The profile is having an inside conductor and also indicating a pulse source.

FIG. 2 is a top view of a motor having a rotor and four armatures in close proximity to the rotor with a shaft and bearings to rotate inside the armatures numbered 1 through 4. A conductor is shown between 1 and 3 and another conductor is shown between 2 and 4. This is all inside a motor housing.

FIG. 3 Is showing the side view of the same motor with the shaft and bearings with the motor housing opened up to show rotor and armatures.

FIG. 4 Is showing some of the possible profiles that can be used in this invention.

FIG. 5 Is a side view of a conductor with the classical “right hand rule” and the “left hand rule” magnetic flux lines explained in most text books.

### DETAILED DESCRIPTION OF THE DRAWINGS

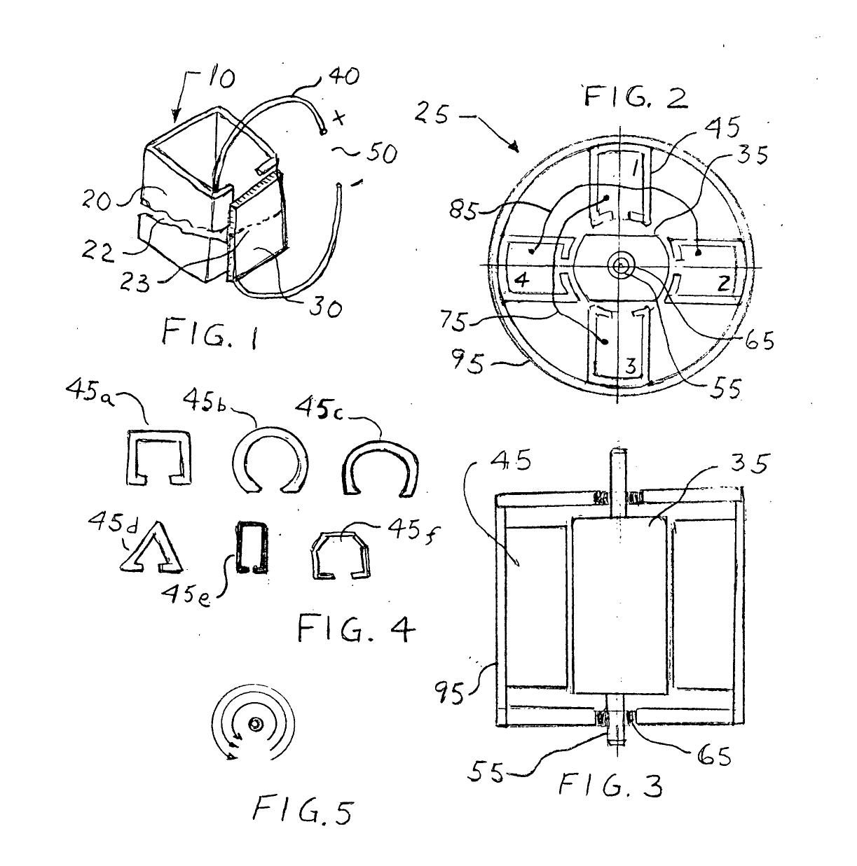

FIG. 1 is showing a soft iron profile 20 and a soft iron armature 30 and a conductor 40 inside the profile. A pulse source is shown at 50. The overall device is numbered 10. Lines 22 and 23 are indicating that both the profile and the armature can be increased or decreased in length to make a much longer assembly then what is shown in FIG. 1

FIG. 2 is a top view of a motor 25 having a rotor 35 and four profiles 45 in close proximity to the rotor 35 with a shaft 55 and bearings 65 to rotate inside the profiles 45.

The profiles 45 are numbered 1 trough 4. A conductor 75 is shown between 1 and 3 and another conductor 85 is shown between 2 and 4, carrying current between a pair of profiles 45 from a source 50.

This is all inside a motor housing 95.

FIG. 3 Is showing the side view of the same motor 25 with the shaft 55 and bearings 65 with the motor housing 95 opened up to show rotor 35 and profiles 45.

FIG. 4 Is showing some of the possible profiles 45 that can be used in this invention. Profiles 45a, 45b, 45c, 45d, 45e and 45f, are shown.

FIG. 5 Is a side view of a conductor 40 with the classical “right hand rule” and the “left hand rule” magnetic flux lines explained in most text books.

Depending if the conductor 40 carries current towards the viewer or away from the viewer the “left or right hand” rule applies.

1. A unique magnetic effect, described as the “ Gerfast effect” comprising:
A soft iron profile with a slot, having an inside conductor in the profile
a mating soft iron armature in close proximity to the profile,
wherein, when the conductor receives a current pulse
the armature and the profile attracts each other and is permanently attracted to each other,
even after the pulse is removed.

2. A unique magnetic effect motor, described as the “ Gerfast effect” comprising:
a central soft iron rotor rotating on a shaft and bearings,
surrounded by a plurality of soft iron, substantially square profiles with gap's, closely spaced with the rotor,
each profile having on the inside a conductor or conductors,
energized by pulses in synchronism with the rotors angular position, creating continuous rotation of the rotor
as long as pulses are supplied.

3. A unique magnetic effect motor, described as the “Gerfast effect” comprising:
a motor having no magnets, no laminations and no multiplicity of copper windings, having a central soft iron rotor rotating on a shaft and bearings,
surrounded by a plurality of soft iron, substantially square profiles with gap's closely spaced with the rotor,
each profile having on the inside a conductor or conductors,
energized by pulses in synchronism with the rotors angular position,
creating continuous rotation of the rotor
as long as pulses are supplied.

4. A magnetic effect according to claim 1 wherein the profile is having varied cross sections shown in FIGS. 4, 45a to 45g.

5. A magnetic effect according to claim 1 wherein
the slot width varies from 5% to 95% of the face of the profile.

6. A magnetic effect according to claim 1 wherein
the armature is having a minimum width being the same as the slot width, and the maximum width being un-limited.

7. A magnetic effect motor according to claim 2 wherein
either the rotor or the armature are processed through an annealing process.

8. A magnetic effect motor according to claim 2 wherein
the substantially square-ish rotor is dimensioned such that two surfaces of the rotor is in close relation to two opposite profiles, but in less close relation with the other two profiles.

9. A magnetic effect motor according to claim 3 wherein
the substantially square-ish rotor is having a convex radius on two opposing surfaces, in close relation to the four profiles, which each is having a concave radius.

10. A magnetic effect motor according to claim 3 wherein
the energizing pulses is synchronized with the rotors angular position using a rotor position sensor combined with transistors.

11. A magnetic effect motor according to claim 10 wherein
the energizing pulses is synchronized with a Hall sensor, optical sensor or using a “sensor-less” electronic chip.

12. A magnetic effect according to claim 1 wherein the slotted profiles and armatures is having varied cross sections shown in FIGS. 4, 45a to 45f, were both profiles and armatures are having long lengths and varied lengths.
